(19) United States
(12) Patent Application Publication
(10) Pub. No.: US 2026/0150160 A1
(43) Pub. Date: May 28, 2026

(54) COOKING APPARATUS

(71) Applicant: SAMSUNG ELECTRONICS CO., LTD., Suwon-si (KR)

(72) Inventors: Geunyong PARK, Suwon-si (KR); Heejin YOON, Suwon-si (KR)

(73) Assignee: SAMSUNG ELECTRONICS CO., LTD., Suwon-si (KR)

(21) Appl. No.: 19/455,560

(22) Filed: Jan. 21, 2026

Related U.S. Application Data
(63) Continuation of application No. PCT/KR2024/008704, filed on Jun. 24, 2024.

(30) Foreign Application Priority Data
Aug. 28, 2023 (KR) 10-2023-0113203

(51) Int. Cl. H05B 6/12; F24C 15/08

(52) U.S. Cl. CPC H05B 6/1209; F24C 15/08

(57) ABSTRACT

A cooking apparatus including a main body in which an induction heating coil is received; a cooking plate which includes a cooking zone arrangeable to correspond to the induction heating coil; a base frame which is to be fixed to the cooking plate such that while the base frame is fixed to the cooking plate the base frame supports at least one edge portion of the cooking plate; and a coupling frame which is attachable to the base frame and detachable from the base frame, such that while the coupling frame is attached to the base frame, the coupling frame is mounted on the base frame and covers at least on edge portion of the cooking plate.

### CROSS-REFERENCE TO RELATED APPLICATION

This application is a continuation application, under 35 U.S.C. § 111(a), of international application No. PCT/KR 2024/008704, filed Jun. 24, 2024, which claims priority under 35 U.S. C. § 119 to Korean Patent Application No. 10-2023-0113203, filed Aug. 28, 2023, the disclosures of which are incorporated herein by reference in their entireties.

### TECHNICAL FIELD

The present disclosure relates to a cooking apparatus including a replaceable frame.

### BACKGROUND ART

In general, an induction heating cooking apparatus utilizes the principles of induction heating to heat and cook food. The induction heating cooking apparatus may include a glass plate on which a cooking vessel is placed, and an induction heating coil located under the glass plate and configured to generate a magnetic field when a current is applied.

When a current is applied to the induction heating coil and a magnetic field is generated, a secondary current is induced in the cooking vessel, and Joule heat is generated by an electrical resistance of the cooking vessel itself. The cooking vessel is heated by the Joule heat, and food in the cooking vessel is heated.

The induction heating cooking apparatus may include a frame to protect the glass from external impact and to provide an aesthetically pleasing appearance. The frame may be positioned to surround an edge of the glass and fixed with silicone.

However, when the frame is configured to be replaceable, the design of the frame, including its material and color, may be varied to create a variety of appearances for the induction heating cooking apparatus.

### DISCLOSURE

### Technical Problem

The present disclosure is directed to providing a cooking apparatus with a variety of aesthetics.

Further, the present disclosure is directed to providing a cooking apparatus including a replaceable frame.

Further, the present disclosure is directed to providing a cooking apparatus capable of preventing foreign substances from entering between a cooking plate and a frame.

Additional aspects of the disclosure will be set forth in part in the description which follows and, in part, will be obvious from the description, or may be learned by practice of the disclosure.

### Technical Solution

One aspect of the present disclosure provides a cooking apparatus including: a main body to receive an induction heating coil; a cooking plate including a cooking zone arrangeable to correspond to the induction heating coil; a base frame to be fixed to the cooking plate, such that while the base frame is fixed to the cooking plate the base frame supports at least one edge portion of the cooking plate; and a coupling frame attachable to the base frame and detachable from the base frame, such that while the coupling frame is attached to the base frame, the coupling frame is mounted on the base frame and covers at least on edge portion of the cooking plate.

Another aspect of the present disclosure provides a cooking apparatus including: a main body to receive an induction heating coil; a cooking plate to be disposed on an upper side of the main body; a base frame, extending along one edge portion of the cooking plate, to be disposed between the main body and the cooking plate; and a coupling frame to cover at least one edge portion of the cooking plate. The coupling frame is attachable to the base frame and detachable from the base frame, such that while the coupling frame is attached to the base frame, the coupling frame is mounted on the base frame and covers, the coupling frame is configured to be slidable along the base frame.

Another aspect of the present disclosure provides a cooking apparatus including: a main body to receive an induction heating coil; a cooking plate including a cooking zone arrangeable to correspond to the induction heating coil; a base frame extending along at least one edge portion of the cooking plate and to be fixed to a lower surface of the cooking plate; a coupling frame configured to be movable along an extension direction of the base frame on the base frame and mountable to the base frame to allow at least a portion thereof to cover at least one edge portion of the cooking plate; and a fixing member provided to fix the coupling frame to the base frame while the coupling frame is mounted on the base frame.

### Advantageous Effects

A cooking apparatus having various aesthetics may be provided.

Further, a frame of a cooking apparatus may be replaced.

Further, foreign substances may be prevented from entering between a cooking plate and a frame.

Additional aspects of the disclosure will be set forth in part in the description which follows and, in part, will be obvious from the description, or may be learned by practice of the disclosure.

### DESCRIPTION OF DRAWINGS

FIG. 1 is a perspective view of a cooking apparatus according to one embodiment.

FIG. 2 is an exploded perspective view of the cooking apparatus of FIG. 1 according to one embodiment.

FIG. 3 is a perspective view of a cooking plate to which a frame of FIG. 2 is coupled according to one embodiment.

FIG. 4 is an exploded view illustrating a state in which the cooking plate and the frame are disassembled in the cooking apparatus of FIG. 1 according to one embodiment.

FIG. 5 is a cross-sectional view taken along a line A-A′ of FIG. 3 according to one embodiment.

FIG. 6 is a view illustrating a base frame and a coupling frame coupled to one edge of the cooking plate according to one embodiment.

FIG. 7 is a perspective view illustrating a cross-section taken along a line B-B′ of FIG. 3 in which a fixing groove and a fixing member are located according to one embodiment.

FIG. 8 is a view illustrating a state in which the fixing groove and the fixing member of

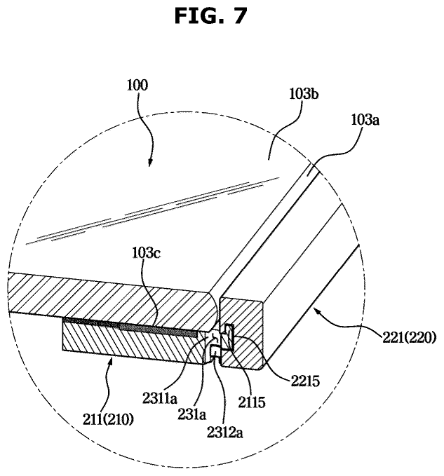

FIG. 7 are disassembled when viewed from a lower side according to one embodiment.

FIG. 9 is a view illustrating a cut portion in which a fixing groove and a fixing member are located according to one embodiment.

FIG. 10 is a view illustrating a state in which a frame and the fixing member are disassembled when viewed from a lower side according to one embodiment.

FIG. 11 is a view illustrating a fixing groove and a fixing member according to one embodiment.

FIG. 12 is an exploded view illustrating the fixing groove and the fixing member of

FIG. 11 according to one embodiment.

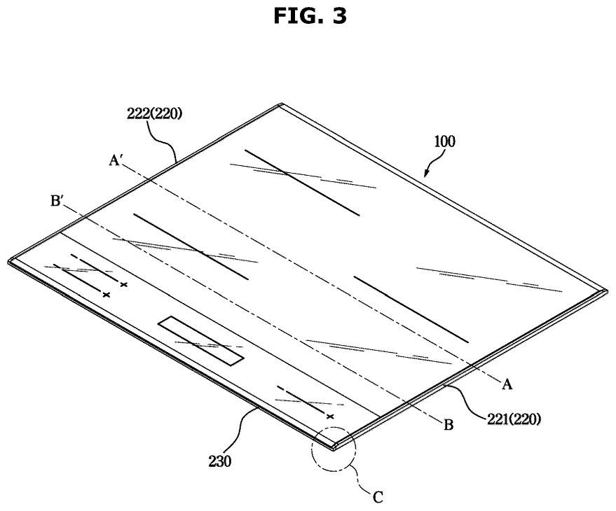

FIG. 13 is an enlarged view of a portion C of FIG. 3 according to one embodiment.

FIG. 14 is a view illustrating a cooking plate to which a frame is coupled according to one embodiment.

FIG. 15 is an exploded perspective view illustrating a state in which the cooking plate and the frame of FIG. 14 are disassembled according to one embodiment.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “up and down direction”, “lower side”, “front and rear direction”, and the like may be defined by the drawings, but the shape and the location of the component is not limited by the term.

Hereinafter exemplary embodiments of the present disclosure will be described in detail with reference to the accompanying drawings.

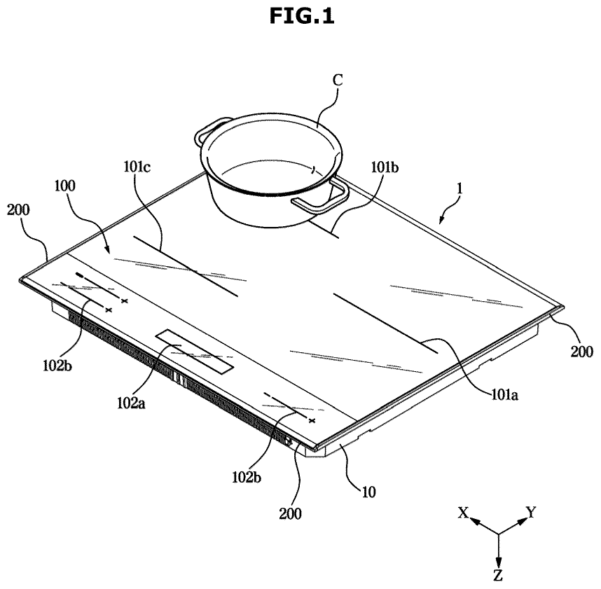

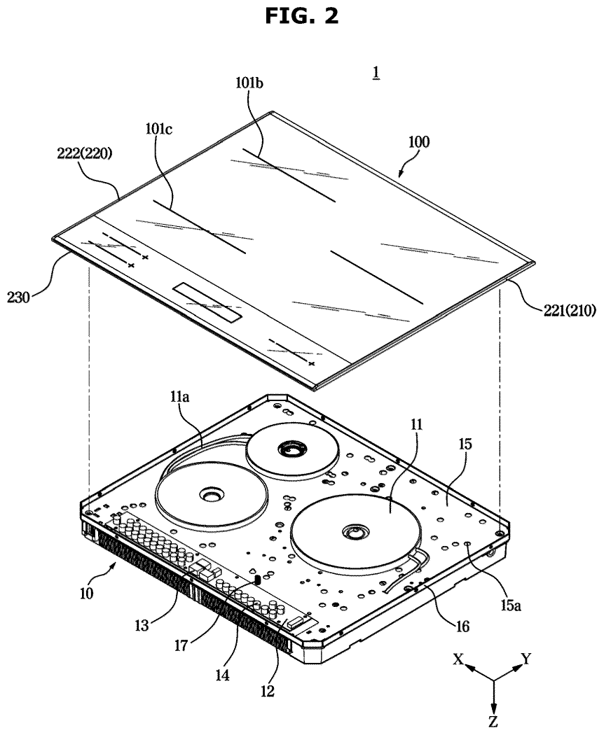

FIG. 1 is a perspective view of a cooking apparatus according to one embodiment. FIG. 2 is an exploded perspective view of the cooking apparatus of FIG. 1.

Referring to FIGS. 1 and 2, a cooking apparatus 1 may include a main body 10, an induction heating coil 11, a circuit board 12, a coil mounting plate 15, an elastic member 17, and a cooking plate 100 disposed on an upper side of the main body 10 and a frame 200.

The main body 10 may form a portion of an exterior of the cooking apparatus 1. The induction heating coil 11 may be received inside the main body 10 and may generate a magnetic field to inductively heat a cooking vessel C. The induction heating coil 11 may be electrically connected to a main board (not shown) disposed inside the main body 10 via a wire 11a.

The cooking plate 100 may include cooking zones 101a, 101b, and 101c corresponding to the induction heating coil 11. The cooking vessel C may be placed in the cooking zones 101a, 101b, and 101c. That is, the cooking zones 101a, 101b, and 101c may be formed on an upper surface of the cooking plate 100. The number and positions of the cooking zones 101a, 101b, and 101c are not limited to the present disclosure.

When a magnetic field passes through a metal forming the cooking vessel C, eddy currents are generated due to the resistance of the metal (for example, iron) of the cooking vessel C. The eddy currents generated in the cooking vessel C may generate heat in the cooking vessel C, thereby heating the food in the cooking vessel C.

The cooking vessel C may include pots, frying pans, steamers, rice cookers, and the like. The types of cooking vessel C are not limited thereto. In the present disclosure, a pot will be used as an example.

The circuit board 12 may be placed under the cooking plate 100. The circuit board 12 may include a display portion 13 and a touch portion 14.

The display portion 13 may be disposed to correspond to a displaying portion 102a on the cooking plate 100. The display portion 13 may display whether the cooking vessel C is heated by the induction heating coil 11. Accordingly, through the displaying portion 102a, a user can check whether the cooking vessel C is heated.

The touch portion 14 may be arranged to correspond to an inputter 102b formed on the cooking plate 100. The touch portion 14 may receive a touch signal from the inputter 102b. For example, the touch portion 14 may receive input using a capacitive touch method. However, the present disclosure is not limited thereto, and the touch portion 14 may also receive input using a pressure-sensitive touch method. A user can control a current flowing to the induction heating coil 11 through the inputter 102b and determine an extent to which the cooking vessel C is heated.

The induction heating coil 11 may be mounted on the coil mounting plate 15. A coil mounting hole 15a for mounting the induction heating coil 11 may be provided on the coil mounting plate 15. A plurality of coil mounting holes 15a may be provided.

The elastic member 17 may be arranged on the coil mounting plate 15. For example, the elastic member 17 may maintain a distance between the coil mounting plate 15 and the cooking plate 100.

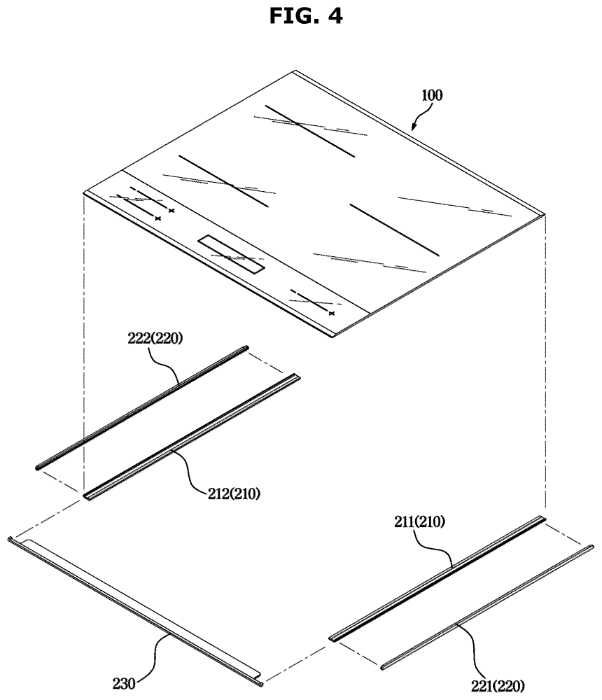

FIG. 3 is a perspective view of a cooking plate to which a frame of FIG. 2 is coupled. FIG. 4 is an exploded view illustrating a state in which the cooking plate and the frame are disassembled in the cooking apparatus of FIG. 1.

Referring to FIGS. 3 and 4, the cooking plate 100 may be coupled to frames 210, 220, and 230. The frames 210, 220, and 230 may protect the cooking plate 100 from impact. The frames 210, 220, and 230 may cover an edge portion 103 of the cooking plate 100. The edge portion 103 of the cooking plate 100 may include a side surface 103a of the cooking plate 100, and one portion of the upper surface 103b and one portion of the lower surface 103c which are adjacent to the side surface.

The frames 210, 220, and 230 may include a base frame 210 provided to support at least one edge portion 110 of the cooking plate 100. The base frame 210 may be fixed to the cooking plate 100. Particularly, the base frame 210 may be fixed to the one edge portion 103 of the cooking plate 100. In the present disclosure, it is illustrated that the base frame 210 is fixed to the one portion 103c of the lower surface in the one edge portion 103 of the cooking plate 100, but may also be fixed to both the one portion 103c of the lower surface and the side surface 103a.

The frames 210, 220, and 230 may include a coupling frame 220 detachably mounted on the base frame 210. A structure in which the coupling frame 220 is coupled to the base frame 210 will be described later.

The coupling frame 220 may be provided to cover the one edge portion 103 of the cooking plate 100. The coupling frame 220 may cover the side surface 103a in the one edge portion 103 of the cooking plate 100. However, the present disclosure is not limited thereto, and the coupling frame 220 may be provided in a form that covers the one portion 103c of the lower surface and the side surface 103a of the one edge portion 103.

The frames 210, 220, and 230 may form a portion of the exterior together with the cooking plate 100. Because the coupling frame 220 covers the side surface 103a of the cooking plate 100, at least a portion of the coupling frame 220 may be positioned at the same height as the cooking plate 100. That is, a portion of the coupling frame 220 may be exposed upward together with the cooking plate 100.

The coupling frame 220 may be formed of various materials. The coupling frame 220 may have various colors and materials. That is, a portion exposed to a user may be formed of various colors and materials, and thus the color and material of the coupling frame 220 may be selected according to the user's preference and taste. The user can also replace the coupling frame 220 as needed. For example, the user can replace the coupling frame 220 with a material that matches the color and material of the cooking plate 100.

The cooking plate 100 may be formed of glass. Particularly, the cooking plate 100 may be formed of tempered glass. The cooking plate 100 may be formed of heat-resistant glass. The cooking plate 100 may be formed of various materials. The cooking plate 100 may have a property that does not allow light to pass therethrough. In addition, the cooking plate 100 may have a property of transmitting a touch signal to the circuit board 12 provided on the lower side through touch.

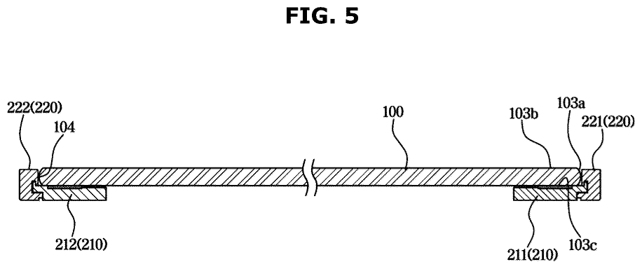

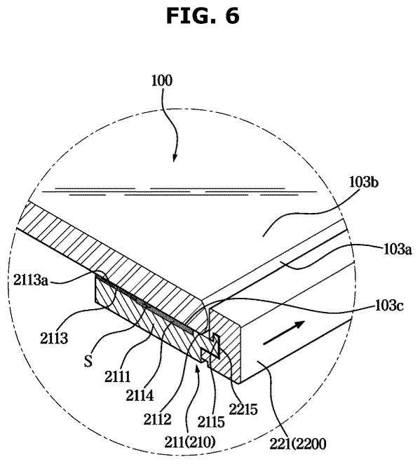

FIG. 5 is a cross-sectional view taken along a line A-A′ of FIG. 3. FIG. 6 is a view illustrating a base frame and a coupling frame coupled to one edge of the cooking plate.

Referring to FIGS. 5 and 6, the frames 210, 220, and 230 may be coupled to at least one edge portion 103 of the cooking plate 100. The frames 210, 220, and 230 may also be coupled to the other edge portion 104 of the cooking plate 100 opposite to the one edge portion 103.

The frames 210, 220, and 230 may include a first base frame 211 and a first coupling frame 221 coupled to the one edge portion 103 of the cooking plate 100, and a second base frame 212 and a second coupling frame 222 coupled to the other edge portion 104 of the cooking plate 100.

The first base frame 211 may be provided to support the one edge portion 103 of the cooking plate 100. The second base frame 212 may be provided to support the other edge portion 104 parallel to the one edge portion 103.

The first coupling frame 221 may be provided to be coupled to the first base frame 211. In addition, the second coupling frame 222 may be provided to be coupled to the second base frame 212. In the present disclosure, it is illustrated that the first coupling frame 221 is located at the left edge portion 103 of the cooking plate 100, and the second coupling frame 222 is located at the right edge portion 104 of the cooking plate 100.

Hereinafter for convenience of description, the description will be based on the frames 211 and 221 coupled to the left edge portion 103 of the cooking plate 100.

The base frame 211 may support the cooking plate 100 from the lower side. The base frame 211 may be fixed to the lower side of the cooking plate 100.

The base frame 211 may include a base portion 2111 extending along the one edge portion 103 of the cooking plate 100. The base portion 2111 may have a length similar to that of the one edge portion 103 of the cooking plate 100.

The base frame 210 may include a support portion 2112 formed stepwise from the base portion 2111. The support portion 2112 may protrude toward the cooking plate 100 to support the cooking plate 100. The support portion 2112 may come into contact with the cooking plate 100.

The support portion 2112 may support the one portion 103c of the lower surface in the one edge portion 103 of the cooking plate 100. The support portion 2112 may be positioned close to the side surface 103a in the lower surface 103c. That is, the support portion 2112 may be positioned close to an outer side of the cooking plate 100 in the base portion 2111.

In order to fix the base frame 211 to the cooking plate 100, an adhesive portion 2113 to which an adhesive member 2113a is attached may be included. For example, the adhesive member 2113a may be a double-sided tape. The adhesive portion 2113 may be formed to protrude from the base portion 2111 toward the cooking plate 100.

The adhesive portion 2113 may be formed with a smaller step than the support portion 2112 to allow the adhesive member 2113a to be attached between the adhesive portion and the cooking plate 100. In addition, the adhesive portion 2113 may be positioned on an opposite side of the support portion 2112. That is, the adhesive portion 2113 may be positioned close to an inner side of the cooking plate 100 in the base portions 2111.

The base frame 211 may include a sealing space S formed between the support portion 2112 and the adhesive portion 2113. The sealing space S may be filled with a sealing member 2114. The sealing member 2114 may have heat resistance and airtightness. For example, the sealing member 2114 may be formed of silicone.

Additionally, the sealing member 2114 may fix the base frame 211 to the cooking plate 100. The sealing member 2114 may prevent foreign substances from entering between the cooking plate 100 and the base frame 211.

The adhesive member 2113a may be attached to the adhesive portion 2113 of the base frame 211, and the sealing member 2114 may be applied to the sealing space S. At this time, the support member 2112 may prevent the sealing member 2114 from flowing out toward the coupling frame 221. When the sealing member 2114 flows toward the coupling frame 221, the coupling frame 221 may be fixed and movement thereof may not be allowed, which needs to be prevented.

The coupling frame 221 may be coupled by sliding along a longitudinal direction of the base frame 211. A method in which the coupling frame 221 is coupled to the base frame 211 is not limited thereto. For example, the coupling frame 221 may also be fitted to the base frame 211. Hereinafter it will be described that the coupling frame 221 is coupled to the base frame 211 by sliding.

The base frame 211 may include a rail protrusion 2115 extending along the longitudinal direction of the base frame 211 to be coupled to the coupling frame 221. The coupling frame 221 may include a rail slot 2215 extending along a longitudinal direction of the coupling frame 221 to allow the rail protrusion 2115 to be inserted thereinto. However, the present disclosure is not limited thereto, and the rail slot may be formed in the base frame 211 and the rail protrusion may be formed in the coupling frame 221.

The base frame 211 may be fixed to the cooking plate 100 by the adhesive member 2113a and the sealing member 2114. That is, the base frame 211 may not move with respect to the cooking plate 100.

The coupling frame 221 is not fixed by the cooking plate 100 and the sealing member 2114, and the like, and may also be movably coupled to the base frame 211 without being fixed thereto. Particularly, the coupling frame 221 may be configured to be movable along the extension direction of the base frame 211.

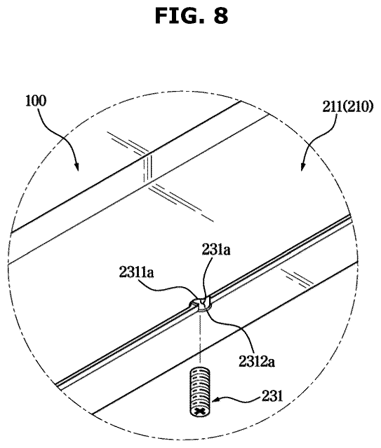

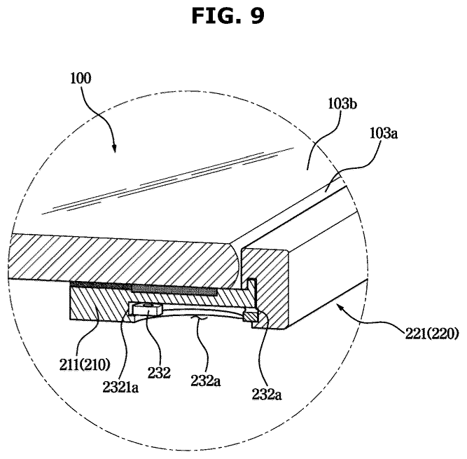

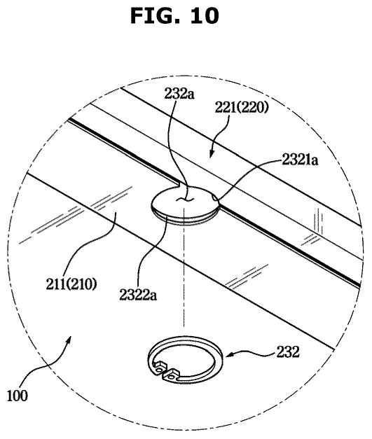

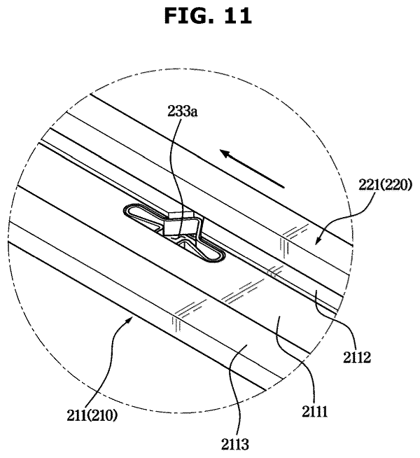

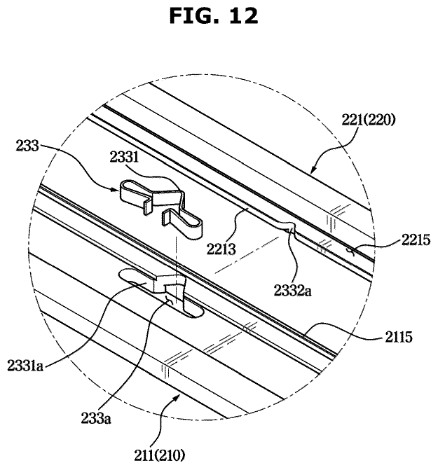

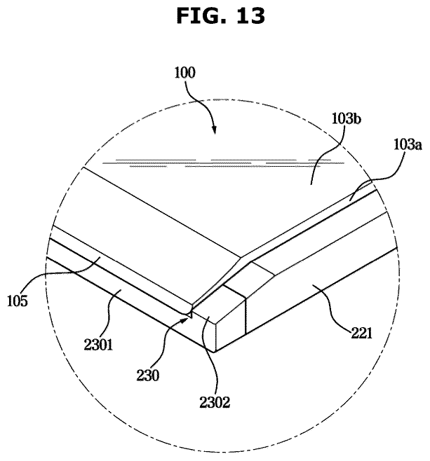

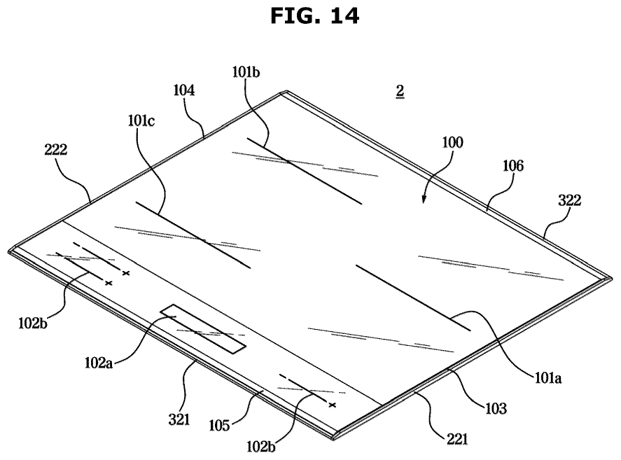

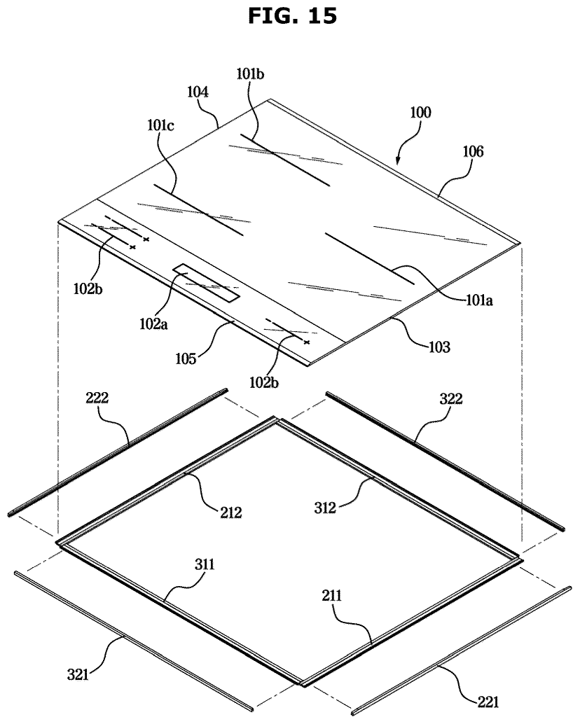

FIG. 7 is a perspective view illustrating a cross-section taken along a line B-B′ of FIG. 3 in which a fixing groove and a fixing member are located. FIG. 8 is a view illustrating a state in which the fixing groove and the fixing member of FIG. 7 are disassembled when viewed from a lower side.

Referring to FIGS. 7 and 8, the coupling frame 221 may be configured to be movable on the base frame 211. Particularly, the coupling frame 221 may be configured to be movable along the extension direction of the base frame 211. The coupling frame 221 may be provided To cover at least one edge portion 103 of the cooking plate 100. In other words, at least a portion of the coupling frame 221 may be arranged adjacent to the edge portion 103 of the cooking plate 100.

The coupling frame 221 needs to be fixed in a correct position while moving on the base frame 211. The correct position may be defined as a position in which the coupling frame 221 corresponds to the one edge portion 103 of the cooking plate 100 while the coupling frame 221 is mounted on the base frame 211.

The cooking apparatus 1 may include a fixing member 231 provided to fix the coupling frame 221 to the base frame 211 to allow the coupling frame 221 to be in the correct position on the base frame 211. The base frame 211 and the coupling frame 221 may form a fixing groove 231a provided to receive the fixing member 231.

As a result, the correct position in the expression of “the coupling frame 221 is in the correct position on the base frame 211” may be defined as a position in which the base frame 211 and the coupling frame 221 form a fixed groove 231a.

The base frame 211 may include a groove forming portion 2311a forming a portion of the fixing groove 231a. The coupling frame 221 may include a groove forming portion 2312a to form the fixing groove 231a together with the groove forming portion 2311a. The groove forming portion 2311a of the base frame 211 and the groove forming portion 2312a of the coupling frame 221 may together form a hole in which the fixing member 231 may be received. The shape of the fixing groove 231a is not limited thereto and may be provided in various forms. The fixing groove 231a may be provided in multiple numbers spaced apart from each other along the longitudinal direction of the base frame 211 and the coupling frame 221.

In the embodiment of the present disclosure, the fixing member 231 may be a spring pin. The spring pin has elasticity. Accordingly, after an external force is applied to reduce a diameter of the spring pin, the spring pin may be inserted into the fixing groove 231a, and when the external force is released, the spring pin may be fixed in the fixing groove 231a. In other words, positions of the base frame 211 and the coupling frame 221 may be fixed.

Alternatively, the fixing member 231 may be a dowel pin. The dowel pin may be provided to match a diameter of the fixing groove 231a. Similarly, the dowel pin may be inserted into the fixing groove 231a to fix the positions of the base frame 211 and the coupling frame 221.

Hereinafter various embodiments of fixing members 232 and 233 and fixing grooves 232a and 233a will be described. Detailed descriptions of the same contents as the fixing member 231 and the fixing groove 231a of FIGS. 7 and 8 will be omitted, and only the different contents will be described.

FIG. 9 is a view illustrating a cut portion in which a fixing groove and a fixing member are located according to one embodiment. FIG. 10 is a view illustrating a state in which a frame and the fixing member are disassembled when viewed from a lower side.

Referring to FIGS. 9 and 10, the cooking apparatus 1 may include a fixing member 232 provided to fix the coupling frame 221 to the base frame 211 to allow the coupling frame 221 to be in a correct position on the base frame 211. The base frame 211 and the coupling frame 221 may form a fixing groove 232a provided to receive the fixing member 232.

The base frame 211 may include a groove forming portion 2321a forming a portion of the fixing groove 232a. The coupling frame 221 may include a groove forming portion 2322a to form the fixing groove 232a together with the groove forming portion 2321a. The groove forming portion 2321a of the base frame 211 and the groove forming portion 2322a of the coupling frame 221 may together form a hole in which the fixing member 232 may be received. The shape of the fixing groove 232a is not limited thereto and may be provided in various forms.

In the embodiment of the present disclosure, the fixing member 232 may be a snap ring. The snap ring may be inserted into the fixing groove 232a after being pressed to reduce a diameter of the snap ring. When a pressed state is released while inserted into the fixing groove 232a, the diameter of the snap ring may be restored by elasticity, and thus the snap ring may be fixed in the fixing groove 232a. In other words, the positions of the base frame 211 and the coupling frame 221 may be fixed.

FIG. 11 is a view illustrating a fixing groove and a fixing member according to one embodiment. FIG. 12 is an exploded view illustrating the fixing groove and the fixing member of FIG. 11.

Referring to FIGS. 11 and 12, the base frame 211 may include a receiving groove forming portion 2331a forming a portion of the receiving groove 233a. The coupling frame 221 may include a pressure release portion 2332a to form the receiving groove 233a together with the receiving groove forming portion 2331a in a correct position.

The receiving groove forming portion 2331a of the base frame 211 and the pressure release portion 2332a of the coupling frame 221 may form a groove in which a fixing member 233 may be received. The receiving groove forming portion 2331a of the base frame 211 and the pressure release portion 2332a of the coupling frame 221 may be positioned to overlap each other. The shape of the receiving groove 233a is not limited thereto and may be provided in various forms.

In the present embodiment, the fixing member 233 may be a leaf spring. The fixing member 233 may include a loading portion 2331 to which an external force is applied. When a pressure is applied to the loading portion 2331, the fixing member 233 may contract and store elastic energy.

The coupling frame 221 may include a pressing portion 2213 provided to press the loading portion 2331 of the fixing member 233 when the coupling frame 221 slides along the longitudinal direction of the base frame 211. The pressing portion 2213 may extend along the longitudinal direction of the coupling frame 221 so as to press the loading portion 2331 while the coupling frame 221 moves on the base frame 211.

A pressed state of the fixing member 233 may be released when the coupling frame 221 is positioned in a correct position while the coupling frame 221 moves on the base frame 211. When the coupling frame 221 passes the correct position, the fixing member 233 may be positioned at the pressure release portion 2332a of the coupling frame 221.

When the coupling frame 221 is in the correct position with the base frame 211, an

external force applied to the loading portion 2331 of the fixing member 233 may disappear. That is, the pressing portion 2213 is configured not to press the fixing member 233 in the correct position.

When the external force applied to the fixing member 233 disappears, the fixing member 233 may be elastically restored by the elastic energy stored in the fixing member 233. That is, the loading portion 2331 of the fixing member 233 may be positioned at the pressure release portion 2332a. Because the loading portion 2331 of the fixing member 233 interferes with the pressure release portion 2332a, a user can recognize that the coupling frame 221 is in the correct position. In addition, the positions of the base frame 211 and the coupling frame 221 may be fixed.

FIG. 13 is an enlarged view of a portion C of FIG. 3.

Referring to FIG. 13, a blocking frame 230 may be arranged perpendicularly to the first base frame 211 and the second base frame 212 (refer to FIG. 3). The blocking frame 230 may be arranged on other edge adjacent to the one edge portion 103 in which the first base

frame 211 is positioned. In addition, the blocking frame 230 may be arranged on other edge portion 105 adjacent to the other edge portion 104 in which the second base frame 212 is positioned. In the present disclosure, it is illustrated that the blocking frame 230 is arranged on the front edge portion 105.

The blocking frame 230 may be disposed on the lower side of the cooking plate 100. That is, the blocking frame 230 may be disposed along the front edge portion 105. The blocking frame 230 may cover a gap in which the cooking plate 100 is spaced upward by the base frames 211 and 212.

The blocking frame 230 may include a blocking portion 2301 positioned under the cooking plate 100. The blocking portion 2301 may have a thickness similar to that of the base frames 211 and 212. Because the blocking portion 2301 is positioned under the cooking plate 100, the blocking portion 2301 may not be visible from above.

The blocking frame 230 may include a cover portion 2302 provided to cover at least a portion of the side surface 103a of the cooking plate 100. The cover portion 2302 may extend from opposite ends of the blocking portion 2301. The cover portion 2302 may be bent upward and extended from the blocking portion 2302. The cover portion 2302 may cover a portion of the side surface 103a of the cooking plate 100 that is not covered by the coupling frame 221. However, the present disclosure is not limited thereto, and the cover portion 2302 may be formed integrally with the coupling frame 221.

Hereinafter other embodiment different from the cooking plate 100, to which the frames 210, 220, and 230 of FIGS. 1 to 13 are coupled, will be described. The same components as those of the embodiments illustrated in FIGS. 1 to 13 are assigned the same reference numerals, and detailed descriptions thereof may be omitted.

FIG. 14 is a view illustrating a cooking plate to which a frame is coupled according to one embodiment. FIG. 15 is an exploded perspective view illustrating a state in which the cooking plate and the frame of FIG. 14 are disassembled.

Referring to FIGS. 14 and 15, a cooking apparatus 2 may include a third base frame 311 provided to be coupled to a blocking frame 321. The third base frame 311 may be disposed on a front edge portion 105 of a cooking plate 100. The third base frame 311 may support the cooking plate 100 from a lower side. Similarly, the third base frame 311 may be fixed to the cooking plate 100. The blocking frame 321 may be slidably coupled to the third base frame 311.

The blocking frames 321 and 322 may also be disposed on a rear edge 106 of the cooking plate 100. At this time, a blocking frame disposed on the front edge 105 of the cooking plate 100 may be referred to as a first blocking frame 321, and a blocking frame disposed on the rear edge 106 of the cooking plate 100 may be referred to as a second blocking frame 322.

The first blocking frame 321 may be coupled to the third base frame 311. Similarly, the second blocking frame 322 may be coupled to a fourth base frame 312.

The first blocking frame 321 may protrude forward from the front edge portion 105 of the cooking plate 100. Similarly, the second blocking frame 322 may protrude backward from the rear edge 106 of the cooking plate 100.

When viewed from above, the first blocking frame 321 may be positioned outside the front edge portion 105 of the cooking plate 100, and the second blocking frame 322 may be positioned outside the rear edge 106. That is, when the cooking apparatus 2 is used, all four edges 103, 104, 105, and 106 of the cooking plate 100 may be provided to allow the frames 221, 222, 321, and 322 to be visible.

The blocking frames 321 and 322 may be detachably mounted on the base frames 311 and 312. The blocking frames 321 and 322 may also have various colors and materials. A user can change the color or material of the blocking frames 321 and 322 as desired, as well as the coupling frames 221 and 222.

The blocking frames 321 and 322 may not necessarily protrude beyond the edges 105 and 106 of the cooking plate 100. That is, all portions may be positioned under the cooking plate 100, like the blocking frame 230 (refer to FIG. 4) of FIGS. 1 to 13.

A cooking apparatus according to one embodiment may include a main body provided to receive an induction heating coil, a cooking plate including a cooking zone corresponding to the induction heating coil, a base frame fixed to the cooking plate to support at least one edge portion of the cooking plate, and a coupling frame detachably mounted to the base frame, and provided to cover at least on edge portion of the cooking plate. According to the present disclosure, the cooking apparatus having various aesthetics may be provided. Further, the frame of the cooking apparatus may be replaced. Further, foreign substances may be prevented from entering between the cooking plate and the frame.

The coupling frame may be coupled by sliding along a longitudinal direction of the base frame. According to the present disclosure, the coupling frame may be easily coupled to the base frame.

The base frame may include a rail protrusion 2115 extending along the longitudinal direction of the base frame to be coupled to the coupling frame. The coupling frame may include a rail slot 2215 extending along a longitudinal direction of the coupling frame to allow the rail protrusion to be inserted thereinto.

The cooking apparatus may further include a fixing member 231, 232, or 233 provided to fix the coupling frame to the base frame while the coupling frame is mounted on the base frame. According to the present disclosure, the coupling frame may be fixed in a correct position.

The base frame and the coupling frame may form a fixing groove 231a or 232a provided to receive the fixing member.

The fixing member may be provided to be elastically deformed. According to the present disclosure, the frame of the cooking apparatus may be replaced.

The base frame and the coupling frame may form a receiving groove 233a formed to receive the fixing member. The coupling frame may include a pressing surface 2213 provided to press the fixing member in response to the coupling frame being coupled to the base frame. A pressed state of the fixing member may be configured to be released in response to the coupling frame being in a correct position with respect to the base frame.

The coupling frame may include a pressure release portion 2332a formed by cutting a portion of the pressing surface to allow the pressed state of the fixing member to be released in response to the coupling frame being in the correct position with respect to the base frame.

The base frame may include a base portion 2111, and a support portion 2112 formed stepwise from the base portion and provided to support the cooking plate. The cooking apparatus may further include a sealing member 2114 disposed between the base portion and the cooking plate and provided to block foreign substances from entering between the cooking plate and the coupling frame. According to the present disclosure, foreign substances may be prevented from entering between the cooking plate and the frame. Further, the base frame may be fixed to the cooking plate.

The support portion may be provided to prevent the sealing member from leaking toward the coupling frame.

The base frame may include a first base frame 211 supporting one edge portion of the cooking plate, and a second base frame 212 supporting other edge portion parallel to the one edge portion. The coupling frame may include a first coupling frame 221 provided to be coupled to the first base frame, and a second coupling frame 222 provided to be coupled to the second base frame.

The cooking apparatus may further include a blocking frame 230 disposed on other edge portion 105 adjacent to one edge portion of the cooking plate to be perpendicular to the first base frame and the second base frame, and including a blocking portion 2301 disposed under the cooking plate. According to the present disclosure, a gap between the main body and the cooking plate may be blocked.

The blocking frame may include a cover portion 2302 extending from the blocking portion to cover at least a portion of a side surface of the cooking plate.

The base frame may further include a third base frame 311 provided to support the cooking plate and provided to be coupled to the blocking frame.

The blocking frame may be detachably mounted on the third base frame. According to the present disclosure, the blocking frame may also be configured to be replaceable.

A cooking apparatus according to one embodiment may include a main body provided to receive an induction heating coil, a cooking plate disposed on an upper side of the main body, a base frame extending along one edge portion of the cooking plate and disposed between the main body and the cooking plate, and a coupling frame provided to cover at least one edge portion of the cooking plate. The coupling frame may be detachably mounted to the base frame and provided to be slidable along the base frame. According to the present disclosure, the cooking apparatus having various aesthetics may be provided. Further, the frame of the cooking apparatus may be replaced. Further, foreign substances may be prevented from entering between the cooking plate and the frame.

The cooking apparatus may further include a fixing member 231, 232, or 233 configured to allow the coupling frame to be coupled to the base frame at a correct position. According to the present disclosure, the coupling frame may be fixed in the correct position.

The cooking apparatus may further include a blocking frame 230 disposed on other edge portion adjacent to one edge portion of the cooking plate and provided to cover a gap between the cooking plate and the main body. According to the present disclosure, a gap between the main body and the cooking plate may be blocked.

A cooking apparatus according to one embodiment may include a main body provided to receive an induction heating coil, a cooking plate including a cooking zone corresponding to the induction heating coil, a base frame extending along at least one edge portion of the cooking plate and fixed to a lower surface of the cooking plate, a coupling frame configured to be movable along an extension direction of the base frame on the base frame and mounted to the base frame to allow at least a portion thereof to cover at least one edge portion of the cooking plate, and a fixing member provided to fix the coupling frame to the base frame while the coupling frame is mounted on the base frame. According to the present disclosure, a gap between the body and the cooking plate may be blocked. Further, the coupling frame may be fixed in a correct position.

The fixing member may be provided to be elastically deformed, and the coupling frame may be detachably mounted on the base frame.

While the present disclosure has been particularly described with reference to exemplary embodiments, it should be understood by those of skilled in the art that various changes in form and details may be made without departing from the spirit and scope of the present disclosure.

1. A cooking apparatus comprising:
a main body to receive an induction heating coil;
a cooking plate including a cooking zone arrangeable to correspond to the induction heating coil;
a base frame, to be fixed to the cooking plate, such that while the base frame is fixed to the cooking plate the base frame supports at least one edge portion of the cooking plate; and
a coupling frame attachable to the base frame and detachable from the base frame, such that while the coupling frame is attached to the base frame, the coupling frame is mounted on the base frame and covers at least on edge portion of the cooking plate.

2. The cooking apparatus of claim 1, wherein
the coupling frame is slidable along a longitudinal direction of the base frame to be attached to the base frame.

3. The cooking apparatus of claim 2, wherein
the base frame comprises: a rail protrusion extending along the longitudinal direction of the base frame to be attached to the coupling frame,
wherein the coupling frame comprises: a rail slot extending along a longitudinal direction of the coupling frame to allow the rail protrusion to be inserted thereinto.

4. The cooking apparatus of claim 1, further comprising:
a fixing member provided to fix the coupling frame to the base frame while the coupling frame is mounted on the base frame.

5. The cooking apparatus of claim 4, wherein
the base frame and the coupling frame form a fixing groove provided to receive the fixing member.

6. The cooking apparatus of claim 4, wherein
the fixing member elastically deformable.

7. The cooking apparatus of claim 6, wherein
the base frame and the coupling frame form a receiving groove formed to receive the fixing member,
wherein the coupling frame comprises a pressing surface provided to press the fixing member based on the coupling frame being attached to the base frame,
wherein a pressed state of the fixing member is configured to be released based on the coupling frame being in a correct position with respect to the base frame to be attached to the base frame.

8. The cooking apparatus of claim 7, wherein
the coupling frame comprises: a pressure release portion formed by cutting a portion of the pressing surface to allow the pressed state of the fixing member to be released based on the coupling frame being in the correct position with respect to the base frame.

9. The cooking apparatus of claim 1, wherein
the base frame comprises: a base portion; and a support portion formed stepwise from the base portion and provided to support the cooking plate,
wherein the cooking apparatus further comprises: a sealing member, between the base portion and the cooking plate, provided to block a foreign substance from entering between the cooking plate and the coupling frame.

10. The cooking apparatus of claim 9, wherein
the support portion is provided to prevent the sealing member from leaking toward the coupling frame.

11. The cooking apparatus of claim 1, wherein
the base frame comprises: a first base frame to support one edge portion of the cooking plate; and a second base frame to support another edge portion parallel to the one edge portion,
wherein the coupling frame comprises: a first coupling frame to be coupled to the first base frame; and a second coupling frame to be coupled to the second base frame.

12. The cooking apparatus of claim 11, further comprising:
a blocking frame disposed on the other edge portion adjacent to one edge portion of the cooking plate to be perpendicular to the first base frame and the second base frame, the blocking frame comprising a blocking portion disposed under the cooking plate.

13. The cooking apparatus of claim 12, wherein
the blocking frame comprises: a cover portion extending from the blocking portion to cover at least a portion of a side surface of the cooking plate.

14. The cooking apparatus of claim 12, wherein
the base frame further comprises: a third base frame to support the cooking plate and provided to be coupled to the blocking frame.

15. The cooking apparatus of claim 14, wherein
the blocking frame is attachable to the third base frame and detachable from the third base frame such that while the blocking frame is attached to the third base frame, the blocking frame is mounted on the third base frame.
